(19) United States
(12) Patent Application Publication
(10) Pub. No.: US 2003/0141289 A1
(43) Pub. Date: Jul. 31, 2003

(54) Automobile heated underside apparatus

(76) Inventor: Bryan T. Fisher, Triangle, VA (US)

Correspondence Address: Guaranteed Patent Services, Patent Agent Sonya C. Harris, 2836 South Meade Street, Arlington, VA, 22206-3148, US

(21) Appl. No.: 09/866,964

(22) Filed: May 29, 2001

(51) Int. Cl. B60L 1/02

(52) U.S. Cl. 219/202; 392/437

(57) ABSTRACT

The present invention provides a heated underside apparatus which removes snow/icy mass buildup from motor vehicles. The invention comprises panel sections located along the lateral peripheral sides of an automobile as well as along the front and back periphery, along the bumpers. The panel sections are comprised of a heating element embedded in a thermally conductive material which radiates thermal energy. The heated underside apparatus is adapted such that it is powered by the power source of the vehicle, i.e., the battery, or an auxiliary power supply operatively connected to the vehicle. In a preferred embodiment of the present invention, the apparatus comprises a feedback system which operates by real time monitoring of temperature and moisture levels to thereby maintain threshold levels above freezing point until the snow/icy mass buildup is removed.

### BACKGROUND OF THE INVENTION

1. Field of the Invention

The invention relates to a heating device that is incorporated onto the entire underside periphery of an automobile. More precisely, this heated underside device will be used specifically to prevent the buildup of snow and slush (Snowy Mass Buildup) at the wheels, as well as provide preventative measures for areas where accumulation is prevalent, (e.g., the lateral undersides of the car between the front and rear wheels).

2. Background of Related Art

Many types of automobiles (cars, trucks, buses) are exposed to winter conditions that are subject to “Snowy Mass Buildup”; hereafter SMB. SMB consists of snow, ice and combinations thereof which produce a slushy mass. While stationary and during movement of the automobile through such conditions, there is a high probability that SMB will accumulate along the periphery of the vehicle. This periphery consists of the front and back wheel arcs, the lateral edges, as well as the underside posterior to the front and rear wheels, adjacent the bumpers.

Snowy mass buildup is aesthetically displeasing in that it often has a grayish-brown discoloration, a sign of snow, icy-slush mixing with dirt, rocks, and other debris. But far more important than the cosmetic disadvantage, it also produces a hazard to automobiles in motion releasing this debris. When automobiles travel at normal speeds and release this buildup, it provides projectiles which can be dangerous to vehicles in the path producing possible accident situations. This SMB may also make it virtually impossible to move a parked vehicle with buildup around its periphery impeding motion of the wheels.

The U.S. Pat. No. 5,998,770 to Sundby discloses a heated bed liner that prevents freezing of edible goods inside the vehicle. It teaches of the general concept of a heated assembly located within an automobile, but is unrelated as it maintains heated goods for cargo. U.S. Pat. No. 5,897,802 to Jones discloses a heated debris shield aimed at detecting snow or ice, and then heating up to remove it. However, this device is directed only to the wheel device as it claims to be mounted on the vehicle's ground engaging means. The aforementioned patent also requires a complex construction. Detectors and other highly technical equipment which are utilized by the heated debris shield are too laborious and allow for various mechanical failures. Finally, U.S. Pat. No. 6,140,609 to Jones discloses a heated running board device which functionally removes snow, rain, and ice from the stepping surface, thus allowing for safe entrance into the vehicle.

### SUMMARY OF THE INVENTION

The present invention provides a heated underside apparatus which removes snowy mass buildup from motor vehicles. The invention comprises a heated shield assembly located along the lateral peripheral sides of an automobile as well as along the front and back end periphery, along the bumpers. A simple heated polyurethane, or known equivalents, paneling that fits under the molding would be a most efficient means of eliminating SMB. The heated shield assembly is adapted such that it is powered by the power source of the vehicle, i.e., the battery. In a preferred embodiment of the present invention, the assembly comprises a simple feedback system which operates by maintaining an ambient temperature above freezing point until the SMB is removed.

An advantage of the present invention is that snow and ice can be easily removed to enable motion of the vehicle, thus encouraging mobility. Another advantage of the present invention is that snowy mass can be removed prior to moving, to avoid hazardous driving conditions caused by dislodged buildup.

Yet another advantage is that the present invention may be used on all types and sizes of vehicles, being a feature installed during assembly by the manufacturer. This is unlike the prior art, such as Jones '609 which may be practical for use on semis and large trucks, but is not practical for smaller cars, and especially luxury automobiles. While the design of the Heating Underside Apparatus is vulnerable to use in many forms, detailed explanation and drawings of this will device will provide a clear idea of the exact purpose and design of this invention.

### BRIEF DESCRIPTION OF DRAWINGS

FIG. 1 is a lateral view of a vehicle.

FIG. 2 is a lateral view of a vehicle with a depiction of Snowy Mass Buildup in the designated accumulation areas.

FIG. 3 is plane view of the underside of an automobile with the heated underside apparatus in place.

FIG. 4 is a plane view of a panel section of the heated underside apparatus.

FIG. 5 is a schematic view of the entire device.

FIG. 6 is a flow chart illustrating the operation of the apparatus

### DETAILED DESCRIPTION

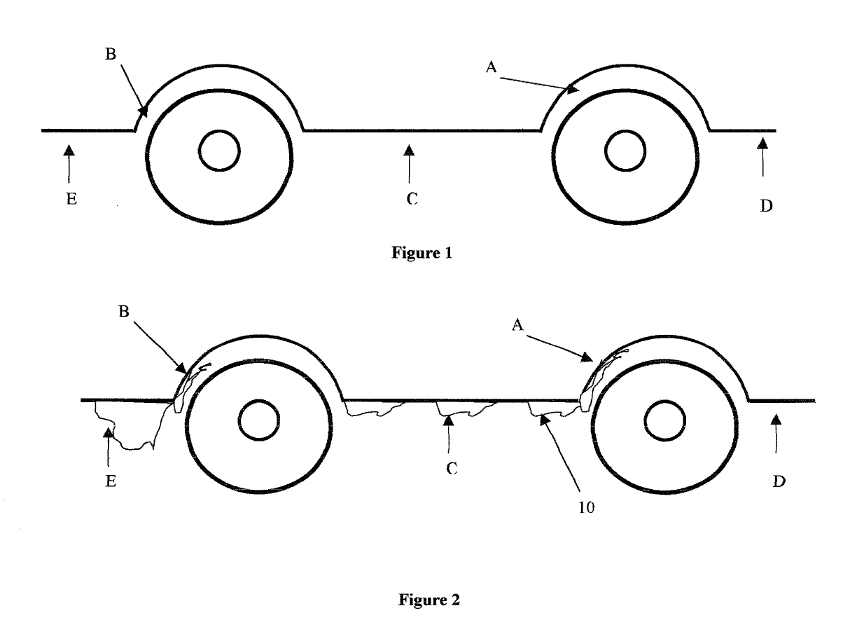

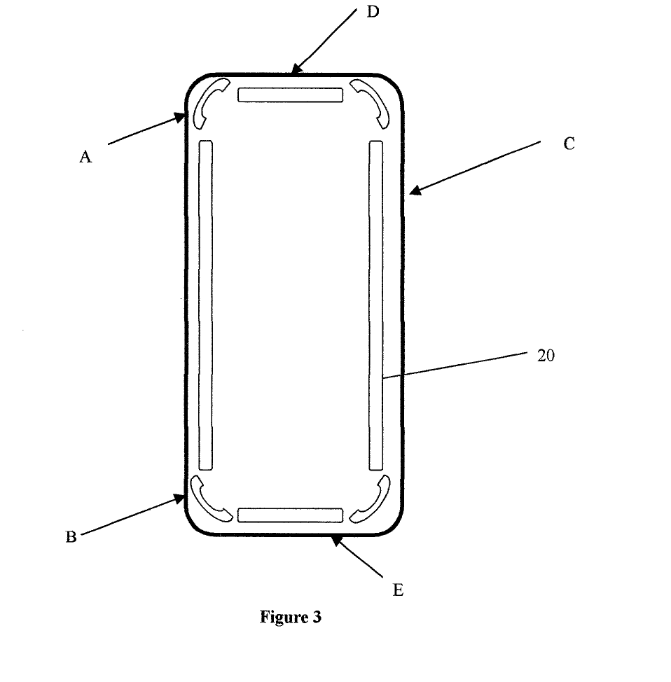

FIG. 1 depicts the lateral view of an automobile, illustrating the underside's relationship to the wheels and ground. FIG. 2 depicts the lateral view of an automobile depicting snowy mass buildup in the designated accumulation areas. Arrows A,B,C,D, and E point to venerable areas where snowy mass will build up on automobiles. A indicates the front wheel well area; B indicated the rear wheel well areas; C indicates the lateral undersides; b indicates the front end of the vehicle including the front bumper; and E indicates the rear end of the vehicle including the rear bumper.

FIG. 3 illustrates the underside of an automobile with the heated underside apparatus in place. The apparatus consists of panel sections 20 which extend around the underside-periphery of the vehicle. These panels are strategically placed at the accumulation areas (A-E) of the underside of the vehicle. The panel sections operate as a complete system with each panel 20 being connected in parallel to the power source 40 and control system 50. Each panel 20 provides signals indicative of the surrounding temperature and moisture level, thus indicating detection of snowy/icy mass buildup at the designated accumulation areas (A-E). Since each panel provides independent signal data, the control system 50 may terminate operation of the panels independent of one another, once SMB removal is sensed.

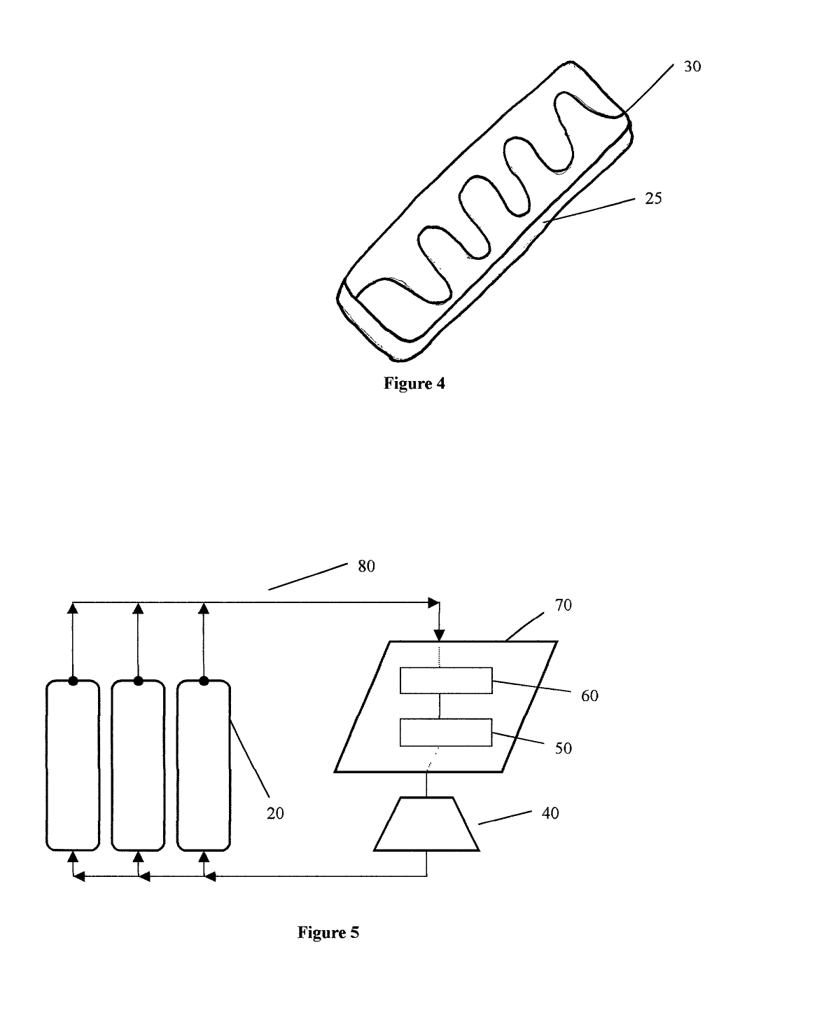

FIG. 4 illustrates a panel section 20 of the heated underside apparatus. Each panel 20 is comprised of a electrically non-conductive material 25 that is also thermally conductive. Molded inside the material 25 is a heating element 30. The heating element 30 is an electrical conductor serving as the conduit for the flow of electrons and is essentially an electric resistor. The electron flow produces electric energy due to the resistivity, which thus produces heat energy. The heating element 30 traverses between lateral edges in a sinusoidal manner along the longitudinal plane of the panel 20. This heat energy heats the thermally conductive material 25 to a temperature above freezing point which thereby melts the surrounding SMB.

The thermally conductive material 25 can be made of any durable material, preferably a plastic which is able to withstand high temperatures as required when power is supplied to the heating element 30. An example of such a material is UHMW (Ultra High Molecular Weight polyethylene) because of its low weight and ability to withstand high temperatures and high durability. It is also possible to use other polymeric materials including, but not limited to polypropylene, polyvinyl chloride, polyurethane, polybutadiene, and natural rubber. It is also possible to use other suitable materials such as metals, metal alloys and wood.

FIG. 5 is a schematic diagram of the electric circuit of the apparatus. The panels 20 are connected in parallel to line 80 which sends and receives electrical signals to and from the feedback system 70. The panels are each parallel connect to the power source 40. The feedback system 70 consists of a sensor 60 and a controller 50. The panels 20 provide temperature and moisture level signals supplied by the heating element conductor 30. The sensor means 60 comprises a temperature sensing device such as a thermocouple, as well as a moisture sensing device. The controller 50 is connected to the sensor means 60 and receives the temperature and moisture data and compares the data to preset temperature and moisture thresholds. These thresholds are related to values above freezing to facilitate SMB removal from the vehicle.

In as much as the panels 20 are each connected to the feedback system 70 and power source 40 in parallel, independent signal information is relayed to the sensor means 60 and processed accordingly by the controller 50, thus selective activation/deactivation of each panel section occurs. In this manner, the electrical heating element 30 will only be activated when required by atmospheric conditions. This will lead to longevity of the panel sections 20 and the heating elements 30 contained therein, as well as curtailing excess power usage.

In addition, since real time atmospheric conditions are provided to the sensor means while the vehicle is in operation (i.e., while power is being supplied to the apparatus), if snowy buildup is detected on any of the panel sections 20, the controller 50 initiates the power source 40 to activate the heating element 30 to thereby avoid hazardous conditions while using the vehicle.

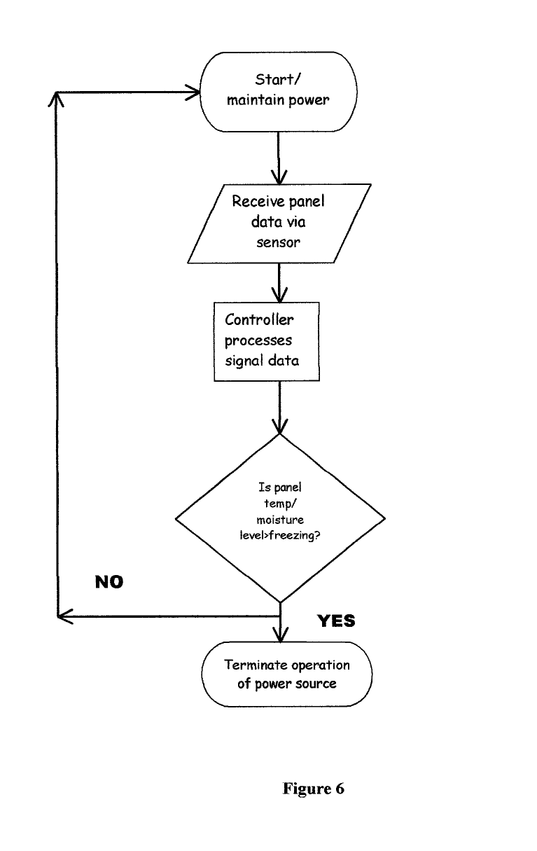

FIG. 6 is a flow chart depicting the operation of the present invention. Initially the power source is initiated to send voltage to the heating element. Data is received from the panel via the sensors. The controller processes the signal data. If the panel temperature and/or moisture level indicates snow/ice detection, then the power is maintained. If the panel temperature and/or moisture level indicates no buildup of snowy/icy mass then the power source is terminated.

The present invention has been described in detail with particular reference to these preferred embodiments, other embodiments can achieve similar results. For example, the system can also be operated by an independent voltage source, supplying separate or independent current to the heating element 30. One example of an independent power source is through the use of a low voltage battery to supply current to the heating element 30. This embodiment allows for a low cost retrofit unit that does not have to be connected the vehicle's battery.

The automobile may contain an ON/OFF switch for manual activation and/or deactivation of the apparatus. Such an activation switch may be connected directly to the power source to thereby initiate activation of the heating elements 30 within the panels 20. The heating underside apparatus may also be activated remotely by remote control device which transmits signals to a receiver located within the controller 50.

In the interest of power preservation, the apparatus may incorporate a timer circuit. The timer may be employed to avoid high current usage which may be required to operate the apparatus. The timer is set for a predetermined time period necessary to heat the panel to a sufficient temperature for a prescribed amount of time to melt contact snow/ice. The timer sequence may be aborted if necessary by moving the switch to the OFF position. Similarly, the switch may be placed in the ON position to re-activate the apparatus and thus restart the timer.

Variations and modifications of the present invention will be obvious to those skilled in the art and it is intended to cover in the appended claims all such modifications and equivalents. It is therefore intended that all matters in the foregoing description and shown in the accompanying drawings be interpreted as illustrative and not in a limiting sense. Thus, the scope of the invention should be determined by the appended claims and their legal equivalents.

What is claimed is:

1. A heated underside apparatus for use with an automobile for the removal of snow/ice accumulation, said apparatus comprising:
a set of panel sections configured for being attached to the peripheral edges of the underside of said automobile,
said panel sections extending around the circumference of the automobile such that
said panel sections extend underneath the two lateral edges of the automobile, beneath the underside of the front and rear ends, including the respective bumpers, and along the front and rear wheel wells;
each panel section containing a heating element for producing thermal energy to melt snow/ice accumulation,
said heating element being embedded within an electrically insulating and thermally conductive material,
a power source operatively connected to the panel sections.

2. The heated underside apparatus of claim 1, further comprising
a feedback system connected to said panel sections for monitoring operation of the panels; and
wherein said heating element is comprised of an electrical conductor, said conductor traversing the length of each panel section between lateral edges in a sinusoidal manner along a longitudinal plane of the panel, said heating element being connected to a power source.

3. The heated underside apparatus of claim 2, wherein
each panel section is electrically connected in parallel to both the feedback system and the power source;
said feedback system is adapted to receive and relay sensed signals pertaining to temperature and moisture levels; and
said power source is adapted to selectively supply voltage to the panels sections.

4. The heated underside apparatus of claim 3, wherein
said feedback system comprises a sensor means electrically connected to the panel sections, said means comprising temperature and moisture sensors, and
wherein said feedback system is further configured to detect proper operation of said panel sections and provide signal data to an indicator; and
a controller for receiving signals from the temperature and moisture sensors to thereby control voltage supply of the power source to said panel sections.

5. The heated underside apparatus of claim 4, wherein
said power source is the automobile battery.

6. The heated underside apparatus of claim 3, wherein
said power source is an auxiliary power source, external to the automobile battery.

7. The heated underside apparatus of claim 4, wherein
said power supply is connected to an ON/OFF switch adapted to the automobile for manual activation of the heated underside apparatus.

8. The heated underside apparatus of claim 4,
further comprising a remote controller for switching the power supply on for activation of the heated underside apparatus.

9. A method for removing accumulated snow and icy buildup, and the like, from an automobile, said method comprising the steps of:
providing a heated underside apparatus, said heated underside apparatus comprising
a set of panel sections configured for being attached to the peripheral edges of the underside of said automobile,
said panel sections extending around the circumference of the automobile such that said panel sections extend underneath the two lateral edges of the vehicle, beneath the underside of the front and rear bumpers, and along the front and rear wheel wells;
each panel section containing a heating element for producing thermal energy to melt snow/ice accumulation,
said heating element being embedded within an electrically insulating and thermally conductive material;
electrically connecting said apparatus to a power source,
heating at least one of said panel sections with electric energy supplied by the power source,
controlling the electrical energy supplied to said panels.

10. A method for removing snow and icy mass buildup, and the like, from an automobile as in claim 9 including:
further providing a feedback system connected to said panel sections for monitoring operation of the panels; and
further providing said heating element with an electrical conductor which traverses the length of each panel section between lateral edges in a sinusoidal manner along a longitudinal plane of the panel for conducting electricity and thereby heating the panels with thermal energy; and
providing temperature and moisture sensors electrically connected to said panel sections.

11. A method for removing snow and icy mass buildup, and the like, from an automobile as in claim 10, further comprising the steps of
electrically connecting each panel section in parallel to the feedback system and the power source, respectively; and
sensing the surrounding temperature and moisture levels via signals provided by said temperature and moisture sensors;
receiving and relaying signals with the feedback system pertaining to temperature and moisture levels.

12. The method of claim 11 wherein
said controlling step further includes selectively controlling said power supply to automatically activate or deactivate the panel sections based on temperature and moisture level signals provided by said sensors; and
monitoring panel section operation via said feedback system to thereby provide signals to an indicator alerting inoperation of said panels.

13. The method of claim 12 wherein
said electrically connecting step comprises supplying power via the automobile battery.

14. The method of claim 12 wherein
said electrically connecting step comprises supplying power via an auxiliary power supply external to the automobile battery.

15. The method of claim 12 further comprising the step of
activating said apparatus by an ON/OFF switch connected to said automobile.

16. The method of claim 12 further comprising the step of
activating said apparatus remotely by remote control adapted to activate the power supply.

17. An automobile comprising:
a body,
a power supply carried by said body, and
a heated underside apparatus said apparatus comprising:
a set of panel sections configured for being attached to the peripheral edges of the underside of said automobile,
said panel sections extending around the circumference of the automobile such that said panel sections extend underneath the two lateral edges of the automobile, beneath the underside of the front and rear ends, including the respective bumpers, and along the front and rear wheel wells;
each panel section containing a heating element for producing thermal energy to melt snow/ice accumulation,
said heating element being embedded within an electrically insulating and thermally conductive material.

18. The automobile of claim 17, wherein
said heated underside apparatus further comprises a feedback system connected to said panel sections for monitoring operation of the panels; and
said heating element is comprised of an electrical conductor, said conductor traversing the length of each panel section, traversing between lateral edges in a sinusoidal manner along a longitudinal plane of the panel and adapted to be connected to a power source; and
wherein each panel section is connected in parallel to the feedback system and the power source; and
said feedback system receives and relays sensed signals pertaining to temperature and moisture levels and comprises a sensor means electrically connected to the panel sections, said means comprising temperature and moisture sensors, and
wherein said feedback system is further configured to detect proper operation of said panel sections and provide signal data to an indicator; and
a controller for receiving signals from the temperature and moisture sensors to thereby control voltage supply of the power supply to said panel sections.

19. The automobile of claim 18 wherein
said power supply is the automobile's battery.

20. The automobile of claim 18 wherein
said power supply is an auxiliary power source external to the automobile battery.
